(19) United States
(12) Patent Application Publication
(10) Pub. No.: US 2026/0024071 A1
(43) Pub. Date: Jan. 22, 2026

(54) INITIATING TRANSACTIONS BASED ON BATTERY LEVEL

(71) Applicant: Motorola Mobility LLC, Chicago, IL (US)

(72) Inventors: Amit Kumar Agrawal, Bangalore (IN); Panduranga Reddy Pailla, Bangalore (IN); Shuaib Puzhakkal Kavalathara, Malappuram (IN)

(73) Assignee: Motorola Mobility LLC, Chicago, IL (US)

(21) Appl. No.: 18/775,230

(22) Filed: Jul. 17, 2024

(51) Int. Cl. G06Q 20/32

(52) U.S. Cl. CPC G06Q 20/3227; G06Q 20/3224

(57) ABSTRACT

In aspects of initiating transactions based on battery level, a first mobile device detects that a battery level of the first mobile device is below a threshold battery level and initiates, based on the battery level being below the threshold battery level, a data transaction from a first account associated with the first mobile device to a second account associated with a second mobile device. The first mobile device selects the second mobile device to receive the data transaction based on the second mobile device being within a threshold distance from the first mobile device or belonging to a group of linked devices including the first mobile device and the second mobile device. The first mobile device detects that the battery level is above the threshold battery level and, in response, initiates a second data transaction from the second account to the first account.

### BACKGROUND

The use of network-based finance systems has become commonplace across the world. Users can perform a wide variety of different financial transactions using a network-based finance application, e.g., using a portable device such as a smartphone. While the availability of finance applications can provide a great deal of convenience, it is not without challenges. For instance, payment transactions that involve data transfer over a network can encounter a number of issues, such as data corruption, data latency such as due to network congestion and/or network errors, service disruptions at a payment service, and so forth. Moreover, losing access to the network and/or the financial application itself renders the user unable to access his or her finances. In such situations, the user is inconvenienced, and a particular payment transaction may be delayed and/or fail completely.

### BRIEF DESCRIPTION OF THE DRAWINGS

Implementations of the techniques for initiating transactions based on battery level are described with reference to the following Figures. The same numbers may be used throughout to reference like features and components shown in the Figures.

FIG. 1 illustrates an example system for initiating transactions based on battery level in accordance with one or more implementations as described herein.

FIG. 2 illustrates an example process flow for initiating transactions based on battery level in accordance with one or more implementations as described herein.

FIGS. 3-4 illustrate example transaction graphical user interfaces (GUIs) for initiating transactions based on battery level in accordance with one or more implementations of the techniques described herein.

FIG. 5 illustrates an example process flow for initiating transactions based on battery level in accordance with one or more implementations as described herein.

FIGS. 6-7 illustrate example transaction GUIs for initiating transactions based on battery level in accordance with one or more implementations of the techniques described herein.

FIGS. 8-11 illustrate flow charts depicting example methods for initiating transactions based on battery level in accordance with one or more implementations of the techniques described herein.

FIG. 12 illustrates various components of an example device that may be used to implement the techniques for initiating transactions based on battery level as described herein.

### DETAILED DESCRIPTION

Implementations of the techniques for initiating transactions based on battery level may be implemented as described herein. A mobile device, such as any type of a wireless device, media device, mobile phone, flip phone, client device, tablet, computing, communication, entertainment, gaming, media playback, and/or any other type of computing and/or electronic device, or a system of any combination of such devices, may be configured to perform techniques for initiating transactions based on battery level as described herein. For instance, the described techniques enable access to funds stored in a digital wallet when the mobile device has a dead or low battery.

In an example scenario, a user may manage financial transactions and access funds in an account using a financial application, such as a digital wallet, on a mobile device. A digital wallet is a software-based system that securely stores users' financial information (e.g., credit and debit card information, bank account information), enabling users to make payments without needing to physically carry their cards. Users can make purchases, send and receive money, and pay bills quickly and easily, e.g., online or in physical stores using a smartphone, tablet, smartwatch, computer, etc. For instance, to purchase a service, the user may interact with the digital wallet to create a payment transaction that is intended to transfer a value amount (e.g., a monetary amount) from the user's account to a service provider's account. Accordingly, the digital wallet generates a payment transaction to transfer the value amount from the user's account to the service provider's account and initiates a network process to complete the payment transaction.

However, such scenarios rely on network and mobile device access. That is, if the user loses access to the network and/or the mobile device, the user also loses access to the user's account and the funds therein. For example, if the mobile device's battery is dead, the user may be unable to perform financial transactions, which may cause user inconvenience. Consider a scenario in which the user is on a road trip with her family. The user forgets her physical wallet at home and must rely on her financial application on her mobile device to make payments. If the user's mobile device battery dies, the user is left without access to funds, which can be problematic particularly in emergency situations. Moreover, if a financial transaction was in progress when the battery died, the financial transaction may remain pending, which may introduce delays and/or errors. Thus, such scenarios can cause system errors at various points in the transaction processing pipeline as well as inefficient use of system resources used to process the unresolved and/or incorrectly resolved financial transaction.

Accordingly, techniques described herein can overcome these difficulties by enabling automatic transfers of funds from a digital wallet based on a battery status (e.g., battery level) of a mobile device. The described implementations, for example, support a user's mobile device detecting that a battery level of the mobile device is below a threshold battery level. Based on the detecting, the mobile device may initiate a transfer of funds from a first financial account associated with the mobile device to a second financial account associated with a second mobile device. The second mobile device may belong to a trusted associate of the user, such as a friend or family member, and may be preauthorized or preconfigured as a receiving device for the funds. In implementations, the first mobile device and the second mobile device belong to a group of linked mobile devices, such as a family application that links family members and their devices to a common ecosystem. In some examples, the mobile device may initiate a reverse transfer of the funds from the second financial account to the first financial account once the battery level of the mobile device is above the threshold (e.g., after charging the mobile device).

In implementations, a financial transaction represents a data transaction. For instance, digital payment transactions involve generating, transmitting, and processing various types of data and across a variety of different systems and networks. Thus, such digital payment transactions can be characterized as sets of computational operations much like other operations of a computing device and/or set of computing devices. Accordingly, by enabling automatic initiation of such transactions based on device battery levels, the described techniques can conserve user and system resources (e.g., power, memory, processor bandwidth, network bandwidth, etc.) that may otherwise be used to perform the transaction(s) manually (e.g., via user input). Thus, the described techniques can improve the operation efficiency of computing devices and data networks. Further, user burden can be reduced by performing such transfers automatically while reducing user interaction to initiate and manage the transfers.

While features and concepts of initiating transactions based on battery level can be implemented in any number of environments and/or configurations, aspects of the described techniques are described in the context of the following example systems, devices, and methods. Further, the systems, devices, and methods described herein are interchangeable in various ways to provide for a wide variety of implementations and operational scenarios.

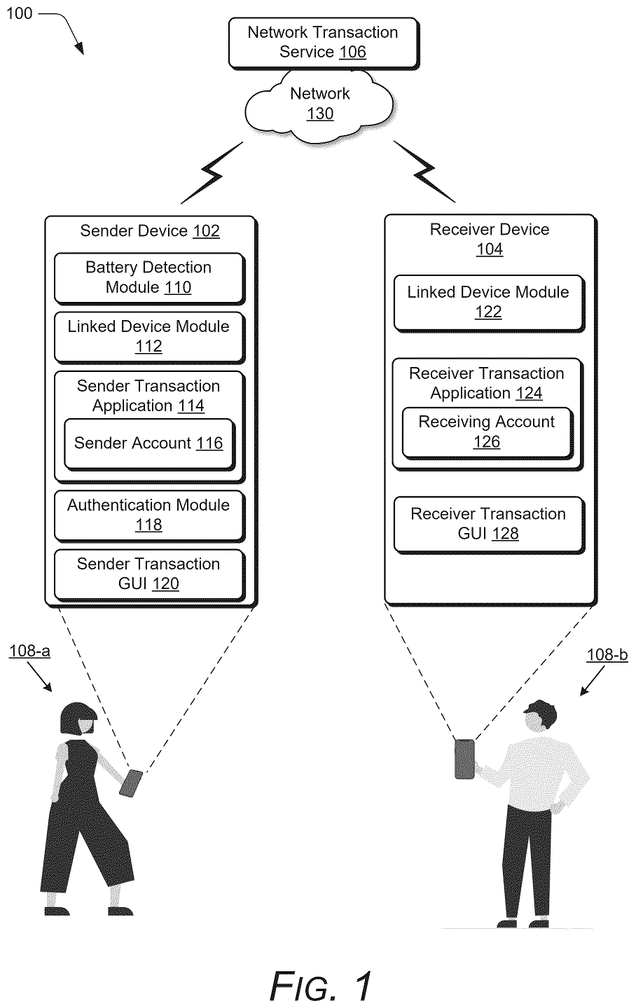

FIG. 1 illustrates an example environment 100 in which aspects of initiating transactions based on battery level can be implemented as described herein. The environment 100 includes a sender device 102, a receiver device 104, a network transaction service 106, and a network 130. The sender device 102 represents a mobile device that can be used by a user 108-a to perform and manage different data transactions (e.g., finance transactions), such as sending digital payments to the receiver device 104. The receiver device 104 represents a mobile device that can be used by a user 108-b and can receive payments such as from the sender device 102.

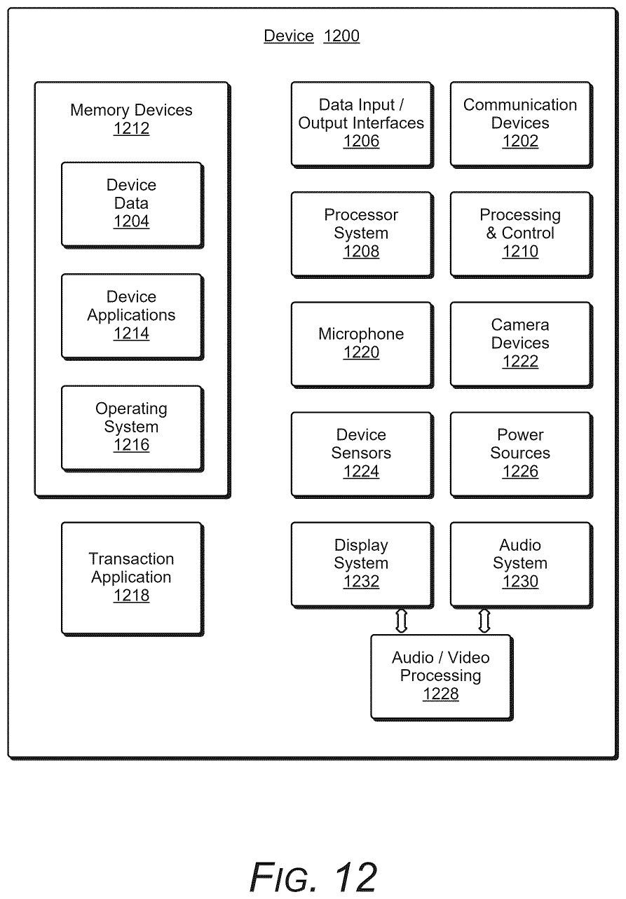

The sender device 102 and the receiver device 104 can be implemented in various ways and include various functionality, examples of which are discussed below with reference to the example device 1200 of FIG. 12. Examples of a mobile device include at least one of any type of a wireless device, mobile device, mobile phone, flip phone, client device, companion device, tablet, computing device, communication device, entertainment device, gaming device, media playback device, any other type of computing and/or electronic device.

The network 130 represents a wireless and/or wired network to which the sender device 102 and the receiver device 104 can connect, such as to enable data communication between the sender device 102 and the receiver device 104 as part of implementations for initiating transactions based on battery level as discussed herein. The network 130 may be implemented using any type of network topology and/or communication protocol, and is represented or otherwise implemented as a combination of two or more networks, to include IP-based networks, cellular networks, and/or the Internet. The network 130 may include mobile operator networks that are managed by a mobile network operator and/or other network operators, such as a communication service provider, mobile phone provider, and/or Internet service provider.

The network transaction service 106 represents a network-based service that is connected to the network 130 and that can participate in various processes pertaining to initiating transactions based on battery level. The network transaction service 106 can be implemented by various entities, such as a banking entity, a digital payment service, a digital wallet (also referred to as a mobile wallet, e-wallet, financial application, or the like), an enterprise entity, a trading entity, a data storage and/or management entity, and/or combinations thereof. The sender device 102 and the receiver device 104, for instance, can interact as part of different stages of finance transactions via the network transaction service 106. The user 108-a, for instance, can utilize a sender transaction application 114 on the sender device 102 to access the network transaction service 106 to perform different finance transactions, such as to transfer value amounts (e.g., monetary value amounts) for different purposes, e.g., to purchase goods and services.

The sender device 102 and the receiver device 104 can each be implemented with various components, such as a processor system and memory, as well as any number and combination of different components as further described with reference to the example device shown in FIG. 12. In implementations, the sender device 102 and the receiver device 104 include various radios for wireless communication with other devices. For example, the sender device 102 and the receiver device 104 can include a Bluetooth (BT) and/or Bluetooth Low Energy (BLE) transceiver, as well as a near field communication (NFC) transceiver. In some cases, sender device 102 and the receiver device 104 include at least one of a Wi-Fi radio, a cellular radio, a global positioning satellite (GPS) radio, or any available type of device communication interface.

The sender device 102 and the receiver device 104 can each include and implement various device applications, such as any type of messaging application, email application, video communication application, cellular communication application, music/audio application, gaming application, media application, social platform applications, and/or any other of the many possible types of various device applications. Many of the device applications have an associated application user interface that is generated and displayed for user interaction and viewing, such as on a display screen of the sender device 102 or the receiver device 104. An application user interface, or any other type of video, image, graphic, and the like can represent digital image content that is displayable on the display screen of the sender device 102 or the receiver device 104.

The sender device 102 and the receiver device 104 each include various functionality that enables implementations of different aspects of initiating transactions based on battery level, as described herein. For example, in the environment 100 for initiating transactions based on battery level, the sender device 102 implements a sender transaction application 114 (e.g., as a device application). As shown in this example, the sender transaction application 114 represents functionality (e.g., logic, software, and/or hardware) enabling aspects of the described techniques for initiating transactions based on battery level. The sender transaction application 114, for example, represents functionality that enables various finance-related transactions to be performed via the sender device 102, including access to the network transaction service 106, transferring value amounts to or from the receiver device 104, and the like. The sender transaction application 114 can be implemented as computer instructions stored on computer-readable storage media and can be executed by a processor system of the sender device 102. Alternatively, or in addition, the sender transaction application 114 can be implemented at least partially in hardware of the device.

In one or more implementations, the sender transaction application 114 includes independent processing, memory, and/or logic components functioning as a computing and/or electronic device integrated with the sender device 102. Alternatively, or in addition, the sender transaction application 114 can be implemented in software, in hardware, or as a combination of software and hardware components. In this example, the sender transaction application 114 is implemented as a software application or module, such as executable software instructions (e.g., computer-executable instructions) that are executable with a processor system of the sender device 102 to implement the techniques and features described herein. As a software application or module, the sender transaction application 114 can be stored on computer-readable storage memory (e.g., memory of a device), or in any other suitable memory device or electronic data storage implemented with the controller. Alternatively or in addition, the sender transaction application 114 is implemented in firmware and/or at least partially in computer hardware. For example, at least part of the sender transaction application 114 is executable by a computer processor, and/or at least part of the content manager is implemented in logic circuitry.

The sender device 102 includes various functionality for performing various aspects of initiating transactions based on battery level such as a battery detection module 110, a linked device module 112, the sender transaction application 114, a sender account 116, an authentication module 118, and a sender transaction GUI 120. The battery detection module 110 represents functionality for detecting battery levels of the sender device 102 and determining whether a battery level satisfies a threshold battery level. The linked device module 112 represents functionality for identifying other mobile devices that are part of a group of linked devices including the sender device 102, such as, for example, the receiver device 104. The sender transaction application 114 represents functionality for initiating and performing payment transactions, e.g., based on the battery level of the sender device 102. In implementations, the sender transaction application 114 includes or is an example of a financial application, such as a digital wallet, associated with the sender account 116 (e.g., a bank account, a credit card, a debit card, or any other payment or financial account).

In implementations, the battery detection module 110 detects that a battery level of the sender device 102 is below the threshold battery level, in response to which the sender transaction application 114 initiates a payment transaction (e.g., a data transaction representing a payment transaction) to transfer funds from the sender account 116 to a receiving account 126 associated with a receiving device, such as the receiver device 104. Additionally, in some examples, the battery detection module 110 detects that the battery level of the sender device 102 is above the threshold battery level, and the sender transaction application 114 initiates a reversal of the payment transaction. The reversal may include transferring all or a portion of the funds from the receiving account 126 back to the sender account.

The authentication module 118 represents functionality for authenticating payment transactions performed by the sender transaction application 114. The sender transaction GUI 120 represents a GUI output by the sender device 102 to enable the user 108-a to authenticate, accept, or deny payment transactions, view payment transaction status, and perform other actions pertaining to payment transactions. Further, the sender transaction GUI 120 can include touch input functionality, such as to enable the user 108-a to provide input to the sender device 102 via touch input to the sender transaction GUI 120.

The receiver device 104 represents a device with which the sender device 102 can engage in a data transaction. The receiver device 104 includes various functionality such as a linked device module 122, a receiver transaction application 124, a receiving account 126, and a receiver transaction GUI 128. The linked device module 122 represents functionality for identifying other mobile devices that are part of a group of linked devices including the receiver device 104, such as, for example, the sender device 102. The receiver transaction application 124 represents functionality for participating in different stages of payment transactions, such as receiving payment transactions initiated by the sender device 102, payment transaction reversal processes, and the like. In implementations, the receiver transaction application 124 includes or is an example of a financial application, such as a digital wallet, associated with the receiving account 126 (e.g., a bank account, a credit card, a debit card, or any other payment or financial account different from the sender account 116). The receiver transaction GUI 128 represents a GUI output by the receiver device 104 to enable the user 108-b to accept or deny payment transactions, view payment transaction status, and perform other actions pertaining to payment transactions. Further, the receiver transaction GUI 128 can include touch input functionality, such as to enable the user 108-b to provide input to the receiver device 104 via touch input to the receiver transaction GUI 128.

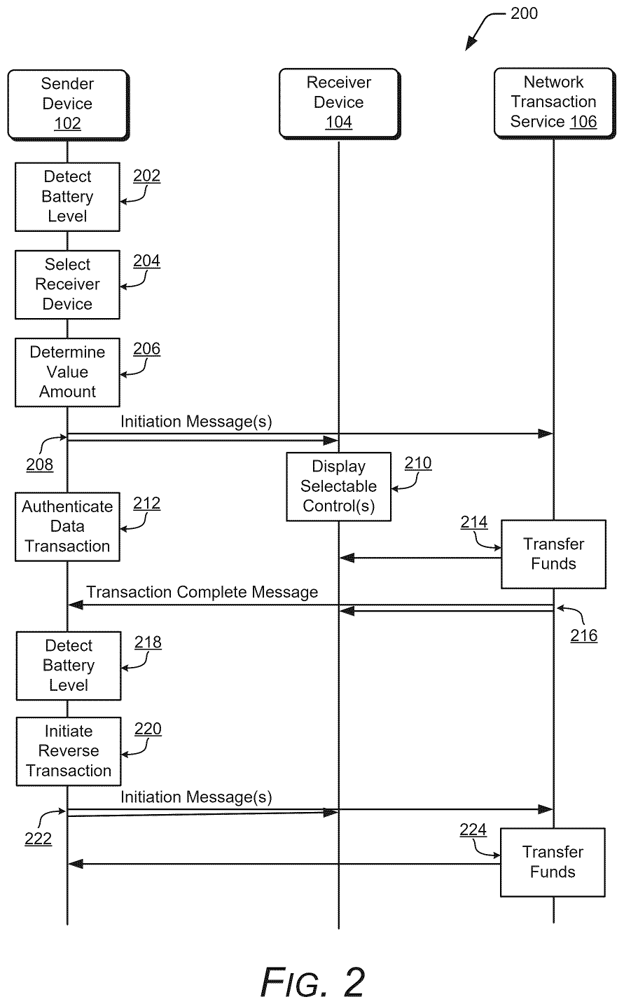

FIG. 2 illustrates a process flow 200 of initiating transactions based on battery level, as described herein. The process flow 200 includes the sender device 102, the receiver device 104, and the network transaction service 106. In the following description of the process flow 200, the operations between the sender device 102, the receiver device 104, and the network transaction service 106 may be performed in a different order than the order shown, or the operations performed by the sender device 102, the receiver device 104, and the network transaction service 106 may be performed in different orders or at different times. Some operations may also be left out of the process flow 200, or other operations may be added to the process flow 200. It is to be understood that while the sender device 102, the receiver device 104, and the network transaction service 106 are shown performing a number of the operations of process flow 200, any device may perform the operations shown.

In some implementations, the sender device 102 and the receiver device 104 may belong to a same group of linked devices. For example, the sender device 102 and the receiver device 104 may both be registered with a same application, such as the linked device module 112 and/or the linked device module 122, that configures the group of linked devices to include the sender device 102 and the receiver device 104. The application may be a location sharing application, such as a family application that shares location information for each device in the group of linked devices. Additionally, or alternatively, the application may be a financial application, such as a digital wallet, and the group of linked devices may be configured as authorized devices for sharing financial information, exchanging finance transactions, or the like, among other examples. In this example, the financial application may be represented by the sender transaction application 114 and the receiver transaction application 124.

At 202, the sender device 102 may detect that a battery level of the sender device 102 is below a threshold battery level. For instance, the battery detection module 110 may detect the battery level of the sender device 102 and may compare the battery level to the threshold battery level. The threshold battery level may be a percentage of a total battery level of the sender device 102. In some examples, the threshold battery level may be set by a user of the sender device 102, e.g., in device system settings, in the financial application, or the like. Alternatively, the threshold battery level may be preconfigured. For example, the threshold battery level may correspond to a battery level at which the sender device 102 is configured to enter a low power mode, such as a low battery operational mode.

Detecting the battery level as being below the threshold battery level may trigger the sender device 102 to initiate a data transaction from a first account (e.g., the sender account 116) to a second account (e.g., the receiving account 126). The data transaction may include or be an example of a finance transaction of a value amount (e.g., a monetary amount) to be transferred from the sender account 116 to the receiving account 126. In implementations, the sender account 116 is associated with the sender device 102 and the receiving account 126 is associated with the receiver device 104. For instance, the sender account 116 may be a bank account, credit card account, or other financial account belonging to a user of the sender device 102 (e.g., the user 108-a) and connected to the sender transaction application 114. The receiving account 126 may be a bank account, credit card account, or other financial account belonging to a user of the receiver device 104 (e.g., the user 108-b) and connected to the receiver transaction application 124.

At 204, the sender device 102 may select a device to receive the data transaction. In some examples, the sender transaction application 114 may be preconfigured (e.g., by the user 108-a) to select the receiver device 104 to receive the data transaction. In other examples, the linked device module 112 may select the receiver device 104 from the group of linked devices, e.g., based on the receiver device 104 belonging to the group of linked devices. Additionally, or alternatively, the linked device module 112 may select the receiver device 104 based on determining that the receiver device 104 is within a threshold distance from the sender device 102. In some examples, the linked device module 112 may obtain location information associated with the receiver device 104, e.g., from the linked device module 122. In such examples, the linked device module 112 may compare the location information associated with the receiver device 104 to location information of the sender device 102 to estimate a relative distance between the sender device 102 and the receiver device 104. The linked device module 112 may compare the relative distance to the threshold distance to determine whether the receiver device 104 is within the threshold distance.

In some cases, if the sender device 102 and the receiver device 104 are both registered as a group of linked devices within the location sharing application, the linked device module 112 may parse a list of the linked devices from the location sharing application to obtain location information associated with each device of the linked devices. The linked device module 112 may select the receiver device 104 based on the receiver device 104 being relatively closer in location to the sender device 102 than any other devices of the group of linked devices.

At 206, the sender device 102 may determine the value amount for the data transaction. In some examples, the value amount may be preconfigured or otherwise preset, e.g., by the user 108-a, in the sender transaction application 114. Alternatively, the value amount may be selected by the user 108-a. For instance, the sender transaction GUI 120 may cause the sender device 102 to display a prompt requesting the user 108-a to input the value amount. The sender transaction application 114 may select the value amount for the data transaction based on receiving input from the user 108-a.

At 208, the sender device 102 may transmit one or more initiation messages indicating that the data transaction is initiated (e.g., based on the battery level being below the threshold battery level) and, in some cases, indicating the value amount determined at 206. For example, the sender transaction application 114 may transmit an initiation message to the receiver device 104 to inform the receiver device 104 of the impending data transaction. Additionally, or alternatively, the sender transaction application 114 may transmit, to the network transaction service 106, an initiation message indicating a request to initiate the data transaction.

At 210, the receiver device 104 may display one or more selectable controls, e.g., in response to receiving the initiation message at 208. As an example, the receiver transaction application 124 and the receiver transaction GUI 128 may coordinate to cause a selectable control to be presented on a display of the receiver device 104. The selectable control may be selectable by the user 108-b to accept or deny the data transaction. If the user 108-b selects to accept the data transaction, the receiver transaction application 124 may proceed with the data transaction. In some cases, the receiver device 104 may transmit, to the network transaction service 106 and/or the sender device 102, a message indicating that the data transaction is approved, and the network transaction service 106 and/or the sender device 102 may proceed with the data transaction. In some examples, if the user 108-b selects to deny the data transaction, the receiver transaction application 124 may abort the data transaction. The receiver device 104 may then transmit a transaction cancellation message to the network transaction service 106 and/or the sender device 102 indicating that the data transaction has been canceled. The network transaction service 106 and/or the sender device 102 may abort the data transaction in response to receiving the transaction cancellation message.

At 212, the sender device 102 may authenticate the data transaction and may complete the data transaction based on the authenticating. In some cases, the sender transaction application 114 may automatically authenticate the data transaction after initiating the data transaction. That is, the data transaction may be automatically initiated and authenticated by the sender transaction application 114 without input from the user 108-a. In some cases, after authenticating the data transaction, the sender device 102 may transmit, and the network transaction service 106 may receive, an authentication message indicating that the data transaction is authenticated.

Alternatively, to authenticate the data transaction, the sender device 102 may display one or more selectable controls requesting input from the user 108-a. For instance, the sender transaction application 114 and the sender transaction GUI 120 may coordinate to cause a selectable control to be presented on a display of the sender device 102. The selectable control may be selectable by the user 108-a to authenticate (e.g., confirm) the data transaction. Additionally, or alternatively, the selectable control may be selectable by the user 108-a to accept or deny the data transaction. In some examples, if the user 108-a selects to deny the data transaction, the sender transaction application 114 may abort the data transaction. The sender device 102 may then transmit a transaction cancellation message to the network transaction service 106 and/or the receiver device 104 indicating that the data transaction has been canceled.

At 214, the network transaction service 106 may perform the data transaction by transferring funds from the sender account 116 to the second account according to the value amount of the data transaction. The data transaction, for instance, can be performed in response to selection of an accept control presented via the sender device 102.

At 216, the network transaction service 106 may transmit a transaction complete message after transferring the funds at 214. For instance, the network transaction service 106 may transmit a transaction complete message to the sender device 102 and/or the receiver device 104 indicating that the data transaction is complete. In some instances, the network transaction service 106 may transmit the transaction complete message to the sender device 102 and the sender device 102 may transmit the transaction complete message to the receiver device 104.

At 218, the battery detection module 110 may detect that the battery level of the sender device 102 has increased and is now above the threshold battery level. In response, the sender transaction application 114 may initiate a reverse data transaction at 220, e.g., to refund the sender account 116. That is, the reverse data transaction may include or be an example of a second finance transaction of a second value amount to be transferred from the receiving account 126 to the sender account 116. The second value amount may be less than or equal to the value amount. In some cases, the sender transaction GUI may prompt the user 108-a to input the second value amount.

At 222, the sender device 102 may transmit a second one or more initiation messages indicating that the reverse data transaction is initiated (e.g., based on the battery level being below the threshold battery level) and, in some cases, indicating the second value amount. For example, the sender transaction application 114 may transmit a second initiation message to the receiver device 104 to inform the receiver device 104 of the impending reverse data transaction. Additionally, or alternatively, the sender transaction application 114 may transmit, to the network transaction service 106, a second initiation message indicating a request to initiate the reverse data transaction.

At 224, based on receiving the second initiation message, the network transaction service 106 may perform the reverse data transaction by transferring funds from the receiving account 126 to the sender account 116 in accordance with the second value amount. In some cases, the network transaction service 106 may transmit a second transaction complete message to the sender device 102 and/or the receiver device 104 after performing the reverse data transaction.

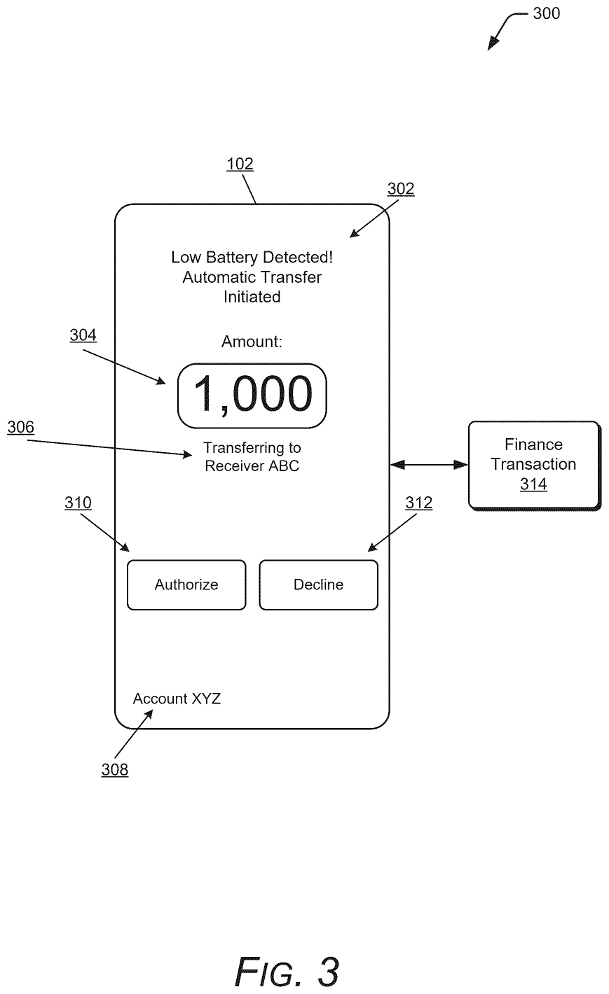

FIG. 3 illustrates an example transaction GUI 300 in accordance with one or more implementations. The transaction GUI 300 may be generated, presented, and/or managed by the sender device 102, the receiver device 104, and/or cooperatively between some combination thereof. For instance, the transaction GUI 300 may be displayed on the sender device 102 in response to the sender transaction application 114 initiating a finance transaction 314, e.g., based on the battery detection module 110 detecting that the battery level of the sender device 102 is below a threshold battery level as described with reference to FIG. 2.

The transaction GUI 300 enables a user to initiate and manage a finance transaction 314. The transaction GUI 300 includes a transfer alert region 302, a transaction amount region 304, a receiving account identifier (ID) 306, and an account ID 308. The transaction GUI 300 also includes an authorize control 310 and a decline control 312, which are selectable to authorize (e.g., accept) and deny the finance transaction 314, respectively.

In the example of FIG. 3, the transfer alert region 302 indicates to a user, such as the user 108-a, that the battery level of the sender device 102 is below the threshold battery level and that the finance transaction 314 has been automatically initiated (e.g., by the sender transaction application 114). The transaction amount region 304 displays a first value amount (e.g., a monetary value amount) of the finance transaction 314, e.g., to be transferred from the sender account 116 to the receiving account 126 associated with the receiver device 104. In some examples, the transaction amount region 304 is selectable by the user 108-a, and the user 108-a can modify the first value amount as desired. The receiving account ID 306 indicates a receiving party (“Receiver ABC”) of the finance transaction 314, such as the receiving account 126, the user 108-b, and/or the receiver device 104. The account ID 308 indicates the sender account 116 (“Account XYZ”) from which the finance transaction 314 originates.

The user 108-a can select the authorize control 310 to authorize the finance transaction 314, based on which the sender device 102 may coordinate with the network transaction service 106 and the receiver device 104 to complete the finance transaction 314, e.g., to transfer the first value amount indicated in the transaction amount region 304 from the sender account 116 to the receiving account 126. Alternatively, the user 108-a can select the decline control 312 to deny the finance transaction 314, based on which the sender device 102 may abort (e.g., terminate) the finance transaction 314.

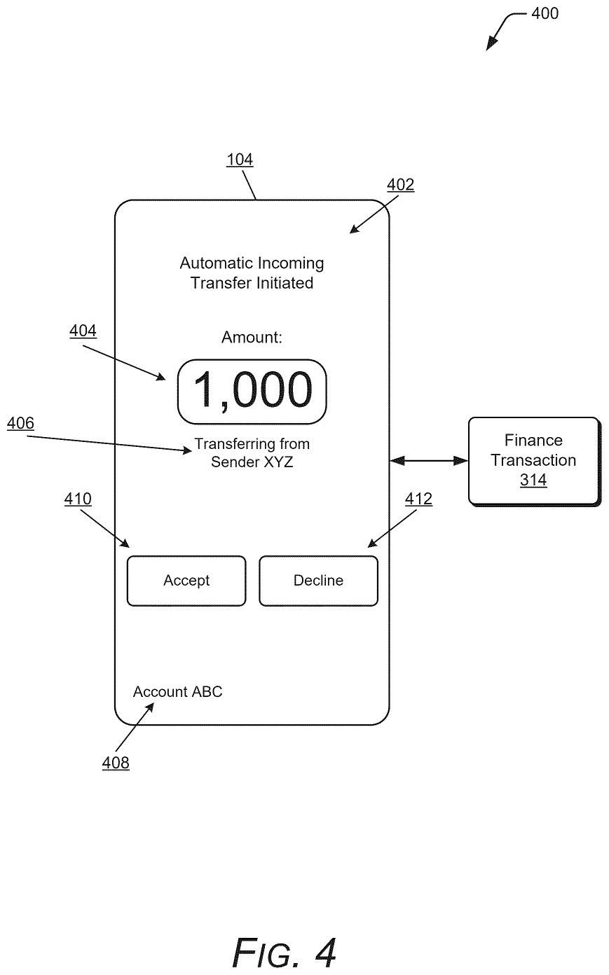

FIG. 4 illustrates a transaction GUI 400 for initiating transactions based on battery level. The transaction GUI 400 may be generated, presented, and/or managed by the receiver transaction application 124, the receiver transaction GUI 128, and/or cooperatively between some combination thereof. The transaction GUI 400 may be displayed on the receiver device 104 in response to the sender device 102 initiating the finance transaction 314.

The transaction GUI 400 enables a user, such as the user 108-b, to manage the finance transaction 314 using the receiver device 104. The transaction GUI 400 includes a transfer alert region 402, a transaction amount region 404, a sender account ID 406, and an account ID 408. The transaction GUI 400 also includes an accept control 410 and a decline control 412, which are selectable to authorize (e.g., accept) and deny the finance transaction 314, respectively.

In the example of FIG. 4, the transfer alert region 402 indicates to a user, such as the user 108-b, that the finance transaction 314 has been automatically initiated (e.g., by the sender transaction application 114). The transaction amount region 404 displays a value amount (e.g., a monetary value amount) of the finance transaction 314, e.g., to be transferred from the sender account 116 to the receiving account 126 associated with the receiver device 104. The sender account ID 406 indicates an initiating party (“Sender XYZ”) of the finance transaction 314, such as the sender account 116, the user 108-a, and/or the sender device 102, from which the finance transaction 314 originates. The account ID 408 indicates the receiving account 126 receiving the finance transaction 314.

The user 108-b can select the accept control 410 to authorize the finance transaction 314, based on which the receiver device 104 may coordinate with the network transaction service 106 and the sender device 102 to complete the finance transaction 314, e.g., to receive the transfer of the value amount indicated in the transaction amount region 404 from the sender account 116 to the receiving account 126. Alternatively, the user 108-b can select the decline control 412 to deny the finance transaction 314, based on which the receiver device 104 may abort (e.g., terminate) the finance transaction 314.

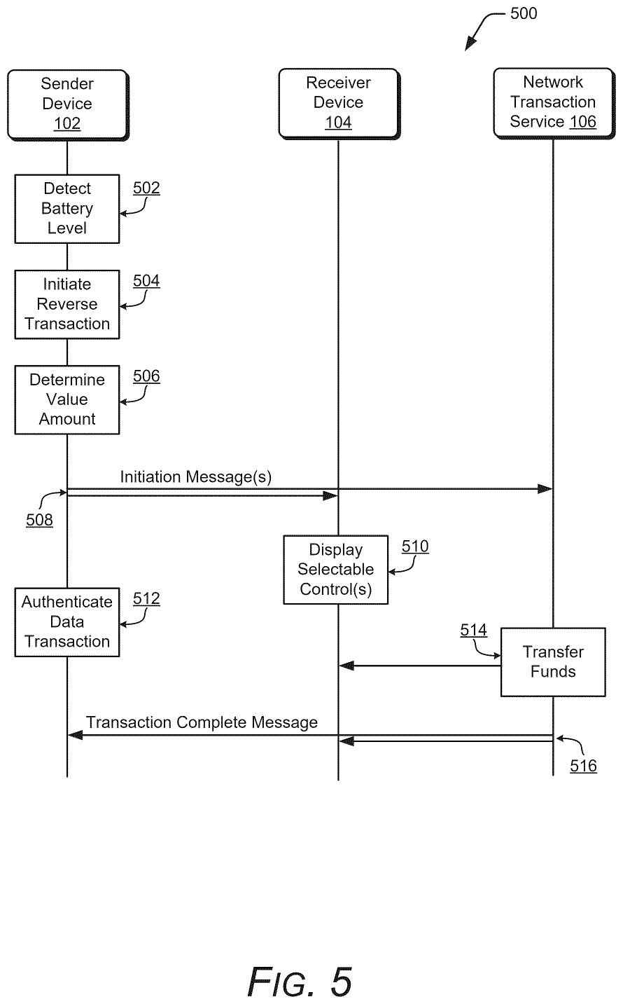

FIG. 5 illustrates a process flow 500 of initiating transactions based on battery level, as described herein. The process flow 500 includes the sender device 102, the receiver device 104, and the network transaction service 106. In the following description of the process flow 500, the operations between the sender device 102, the receiver device 104, and the network transaction service 106 may be performed in a different order than the order shown, or the operations performed by the sender device 102, the receiver device 104, and the network transaction service 106 may be performed in different orders or at different times. Some operations may also be left out of the process flow 500, or other operations may be added to the process flow 500. It is to be understood that while the sender device 102, the receiver device 104, and the network transaction service 106 are shown performing a number of the operations of process flow 500, any device may perform the operations shown.

In some implementations, the sender device 102 and the receiver device 104 may belong to a same group of linked devices. For example, the sender device 102 and the receiver device 104 may both be registered with a same application, such as the linked device module 112 and/or the linked device module 122, that configures the group of linked devices to include the sender device 102 and the receiver device 104. The application may be a location sharing application, such as a family application that shares location information for each device in the group of linked devices. Additionally, or alternatively, the application may be a financial application, such as a digital wallet, and the group of linked devices may be configured as authorized devices for sharing financial information, exchanging finance transactions, or the like, among other examples. In this example, the financial application may be represented by the sender transaction application 114 and the receiver transaction application 124.

As described with reference to FIGS. 1-4, the sender transaction application 114 and the receiver transaction application 124 may perform data transactions to exchange funds between respective accounts, such as a first account (e.g., the sender account 116 associated with the sender device 102) and a second account (e.g., the receiving account 126 associated with the receiver device 104). A data transaction may include or be an example of a finance transaction of a value amount (e.g., a monetary amount) to be transferred to or from the sender account 116 and the receiving account 126.

The process flow 500 illustrates an example scenario in which the sender device 102 initiates a reversal of a finance transaction, for instance, in response to detecting that a battery level of the sender device 102 is above a threshold battery level. For example, the operations of the process flow 500 may occur subsequent to the operations of the process flow 200 as described with reference to FIG. 2. That is, the operations of the process flow 500 may take place after a first finance transaction (e.g., the finance transaction 314) of a first value amount has been completed from the first account (e.g., the sender account 116) to the second account (e.g., the receiving account 126) based on the battery level of the sender device 102 being below the threshold battery level. The user 108-a may, for example, charge the battery of the sender device 102, and once the battery level of the sender device 102 reaches and/or is above the threshold battery level, the sender device 102 may reverse the first finance transaction as described herein. To reverse the first finance transaction, the sender device 102 may initiate a second finance transaction to transfer a second value amount from the second account (e.g., the receiving account 126) to the first account (e.g., the sender account 116). The second value amount may be equal to or less than the first value amount. The second finance transaction may be referred to as a reverse transaction.

At 502, the sender device 102 may detect that a battery level of the sender device 102 is at or above the threshold battery level. For instance, the battery detection module 110 may detect the battery level of the sender device 102 and may compare the battery level to the threshold battery level to determine that the battery level is no longer below the threshold battery level. The threshold battery level may be a percentage of a total battery level of the sender device 102.

At 504, the sender device 102 may initiate the reverse transaction. In some examples, the linked device module 112 may select the receiver device 104 from which the sender device 102 is to receive the reverse transaction, e.g., based on the receiver device 104 being associated with the receiving account 126 to which the first finance transaction was sent by the sender device 102.

At 506, the sender device 102 may determine the second value amount for the reverse transaction. In some examples, the second value amount may be automatically set (e.g., by the sender transaction application 114) to be equal to the first value amount. Additionally, or alternatively, the second value amount may be less than the first value amount. For instance, one or more additional finance transactions may have been performed by the receiving account 126, such as purchases made by the user 108-b, such that the receiving account 126 has less than the first value amount in funds. The second value amount may be automatically set to be equal to a remainder of the first value amount (e.g., equal to funds associated with the first finance transaction that remain in the receiving account 126). In other examples, the second value amount may be preconfigured or otherwise preset, e.g., by the user 108-a, in the sender transaction application 114. Alternatively, the second value amount may be selected by the user 108-a. For instance, the sender transaction GUI 120 may cause the sender device 102 to display a prompt requesting the user 108-a to input the second value amount. The sender transaction application 114 may select the second value amount for the reverse transaction based on receiving input from the user 108-a.

At 508, the sender device 102 may transmit one or more initiation messages indicating that the reverse transaction is initiated (e.g., based on the battery level being at or above the threshold battery level) and, in some cases, indicating the second value amount determined at 506. For example, the sender transaction application 114 may transmit an initiation message to the receiver device 104 to inform the receiver device 104 of the impending reverse transaction. Additionally, or alternatively, the sender transaction application 114 may transmit, to the network transaction service 106, an initiation message indicating a request to initiate the reverse transaction.

At 510, the receiver device 104 may display one or more selectable controls, e.g., in response to receiving the initiation message at 508. As an example, the receiver transaction application 124 and the receiver transaction GUI 128 may coordinate to cause a selectable control to be presented on a display of the receiver device 104. The selectable control may be selectable by the user 108-b to accept or deny the reverse transaction. If the user 108-b selects to accept the reverse transaction, the receiver transaction application 124 may proceed with the reverse transaction. In some cases, the receiver device 104 may transmit, to the network transaction service 106 and/or the sender device 102, a message indicating that the reverse transaction is approved, and the network transaction service 106 and/or the sender device 102 may proceed with the reverse transaction. In some examples, if the user 108-b selects to deny the reverse transaction, the receiver transaction application 124 may abort the reverse transaction. The receiver device 104 may then transmit a transaction cancellation message to the network transaction service 106 and/or the sender device 102 indicating that the reverse transaction has been canceled. The network transaction service 106 and/or the sender device 102 may abort the reverse transaction in response to receiving the transaction cancellation message.

At 512, the sender device 102 may authenticate reverse data transaction and may complete the reverse transaction based on the authenticating. In some cases, the sender transaction application 114 may automatically authenticate the reverse transaction after initiating the reverse transaction. That is, the reverse transaction may be automatically initiated and authenticated by the sender transaction application 114 without input from the user 108-a. In some cases, after authenticating the reverse transaction, the sender device 102 may transmit, and the network transaction service 106 may receive, an authentication message indicating that the reverse transaction is authenticated.

Alternatively, to authenticate the reverse transaction, the sender device 102 may display one or more selectable controls requesting input from the user 108-a. For instance, the sender transaction application 114 and the sender transaction GUI 120 may coordinate to cause a selectable control to be presented on a display of the sender device 102. The selectable control may be selectable by the user 108-a to authenticate (e.g., confirm) the reverse transaction. Additionally, or alternatively, the selectable control may be selectable by the user 108-a to accept or deny the reverse transaction. In some examples, if the user 108-a selects to deny the reverse transaction, the sender transaction application 114 may abort the reverse transaction. The sender device 102 may then transmit a transaction cancellation message to the network transaction service 106 and/or the receiver device 104 indicating that the reverse transaction has been canceled.

At 514, the network transaction service 106 may perform the reverse transaction by transferring funds from the receiving account 126 to the sender account 116 according to the second value amount. The reverse transaction, for instance, can be performed in response to selection of an accept control presented via the sender device 102.

At 516, the network transaction service 106 may transmit a transaction complete message after transferring the funds at 514. For instance, the network transaction service 106 may transmit a transaction complete message to the sender device 102 and/or the receiver device 104 indicating that the reverse transaction is complete. In some instances, the network transaction service 106 may transmit the transaction complete message to the sender device 102 and the sender device 102 may transmit the transaction complete message to the receiver device 104.

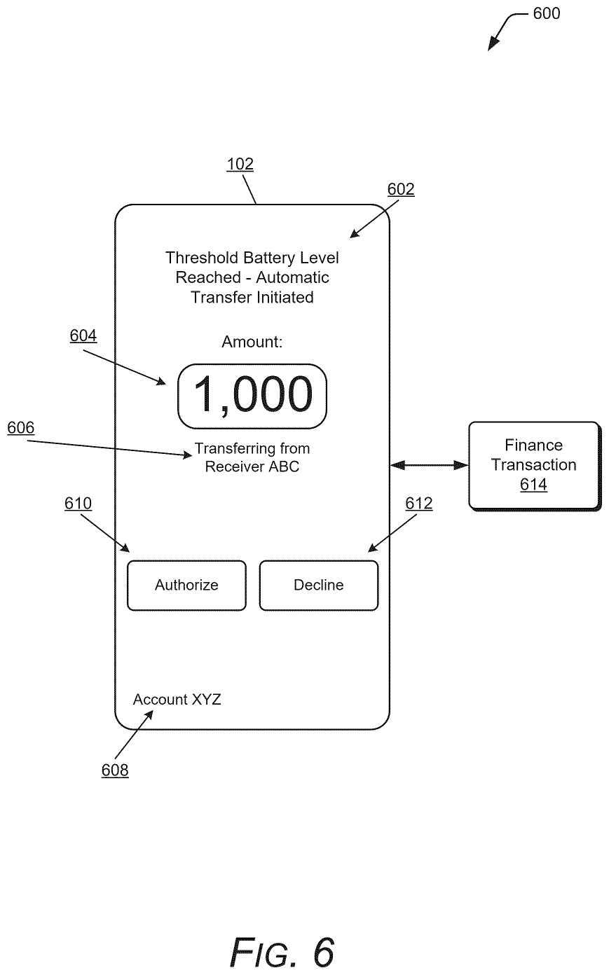

FIG. 6 illustrates an example transaction GUI 600 in accordance with one or more implementations. The transaction GUI 600 may be generated, presented, and/or managed by the sender device 102, the receiver device 104, and/or cooperatively between some combination thereof. For instance, the transaction GUI 600 may be displayed on the sender device 102 in response to the sender transaction application 114 initiating a finance transaction 614, e.g., based on the battery detection module 110 detecting that the battery level of the sender device 102 is at or above a threshold battery level as described with reference to FIG. 5.

The transaction GUI 600 enables a user to initiate and manage a finance transaction 614. The finance transaction 614 may be an example of a reverse transaction as described with reference to FIG. 5. For instance, the finance transaction 614 may occur after the finance transaction 314 has been completed and may reverse the result of the finance transaction 314. That is, the direction of the finance transaction 614 may be opposite to the direction of the finance transaction 314 and may return previously-transferred funds from the receiving account 126 to the sender account 116.

The transaction GUI 600 includes a transfer alert region 602, a transaction amount region 604, a receiving account ID 606, and an account ID 608. The transaction GUI 600 also includes an authorize control 610 and a decline control 612, which are selectable to authorize (e.g., accept) and deny the finance transaction 614, respectively.

In the example of FIG. 6, the transfer alert region 602 indicates to a user, such as the user 108-a, that the battery level of the sender device 102 is at or above the threshold battery level and that the finance transaction 614 has been automatically initiated (e.g., by the sender transaction application 114). The transaction amount region 604 displays a value amount (e.g., a monetary value amount) of the finance transaction 614, e.g., to be transferred from the receiving account 126 to the sender account 116 associated with the sender device 102. The value amount may be equal to or less than a value amount associated with the finance transaction 314. In some examples, the transaction amount region 604 is selectable by the user 108-a, and the user 108-a can modify the value amount as desired. The receiving account ID 606 indicates a party (“Receiver ABC”) from which funds of the finance transaction 614 will be obtained, such as the receiving account 126, the user 108-b, and/or the receiver device 104. Put another way, the receiving account ID 606 indicates the account that received funds of the finance transaction 314 which is being reversed by the finance transaction 614. The account ID 608 indicates the sender account 116 (“Account XYZ”) that initiated the finance transaction 614.

The user 108-a can select the authorize control 610 to authorize the finance transaction 614, based on which the sender device 102 may coordinate with the network transaction service 106 and the receiver device 104 to complete the finance transaction 614, e.g., to transfer the value amount indicated in the transaction amount region 604 from the receiving account 126 to the sender account 116. Alternatively, the user 108-a can select the decline control 612 to deny the finance transaction 614, based on which the sender device 102 may abort (e.g., terminate) the finance transaction 614.

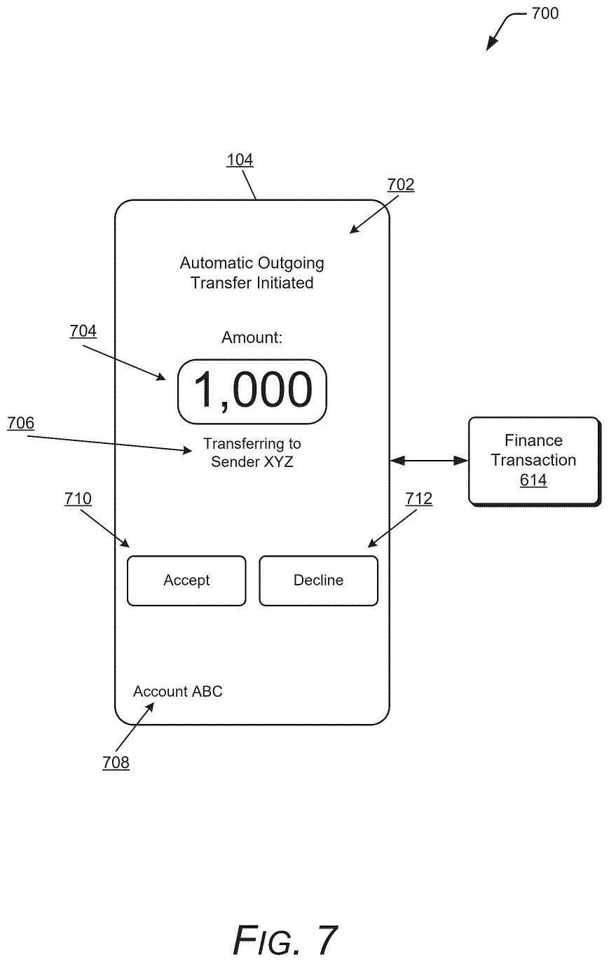

FIG. 7 illustrates a transaction GUI 700 for initiating transactions based on battery level. The transaction GUI 700 may be generated, presented, and/or managed by the receiver transaction application 124, the receiver transaction GUI 128, and/or cooperatively between some combination thereof. The transaction GUI 700 may be displayed on the receiver device 104 in response to the sender device 102 initiating the finance transaction 614.

The transaction GUI 700 enables a user, such as the user 108-b, to manage the finance transaction 614 using the receiver device 104. The transaction GUI 700 includes a transfer alert region 702, a transaction amount region 704, a sender account ID 706, and an account ID 708. The transaction GUI 700 also includes an accept control 710 and a decline control 712, which are selectable to authorize (e.g., accept) and deny the finance transaction 614, respectively.

In the example of FIG. 7, the transfer alert region 702 indicates to a user, such as the user 108-b, that the finance transaction 614 has been automatically initiated (e.g., by the sender transaction application 114). The transaction amount region 704 displays a value amount (e.g., a monetary value amount) of the finance transaction 614, e.g., to be transferred from the receiving account 126 to the sender account 116. The sender account ID 706 indicates an initiating party (“Sender XYZ”) of the finance transaction 614, such as the sender account 116, the user 108-a, and/or the sender device 102, from which the finance transaction 614 originates. The account ID 708 indicates an account from which funds of the finance transaction 614 will be obtained, such as the receiving account 126, the user 108-b, and/or the receiver device 104. Put another way, the account ID 708 indicates the account that received funds of the finance transaction 314 which is being reversed by the finance transaction 614.

The user 108-b can select the accept control 710 to authorize the finance transaction 614, based on which the receiver device 104 may coordinate with the network transaction service 106 and the sender device 102 to complete the finance transaction 614, e.g., to transfer the value amount indicated in the transaction amount region 704 from the receiving account 126 to the sender account 116. Alternatively, the user 108-b can select the decline control 712 to deny the finance transaction 614, based on which the receiver device 104 may abort (e.g., terminate) the finance transaction 614.

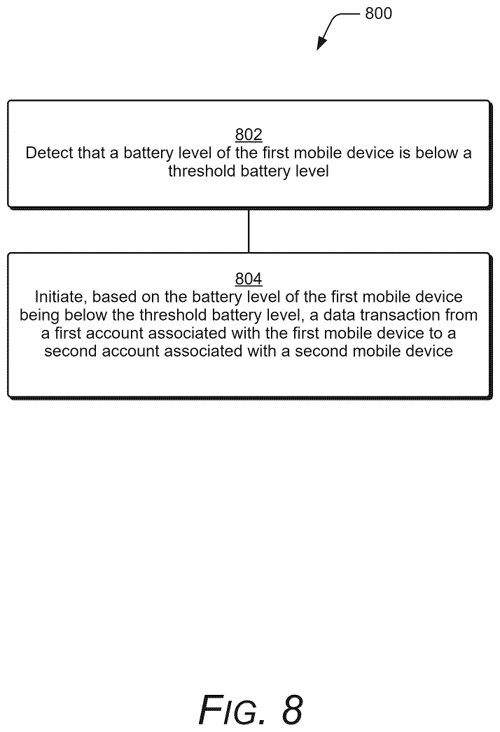

Example methods 800, 900, 1000, and 1100 below are described with reference to respective FIGS. 8, 9, 10, and 11 in accordance with one or more implementations of initiating transactions based on battery level, as described herein. Services, components, modules, managers, controllers, methods, and/or operations described herein can be implemented using software, firmware, hardware (e.g., fixed logic circuitry), manual processing, or any combination thereof. Some operations of the example methods may be described in the context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 8 illustrates example method(s) 800 for initiating transactions based on battery level. The order in which the method is described is not intended to be construed as a limitation, and any number or combination of the described method operations may be performed in any order to perform a method, or an alternate method. Operations of the method 800 may be performed at the sender device 102, the receiver device 104, the network transaction service 106, and/or cooperatively between one or more combinations of these entities.

At 802, a battery level is detected as being below a threshold battery level. For example, the battery detection module 110 may detect that the battery level of the sender device 102 is below the threshold battery level. In some cases, the threshold battery level may be determined by the battery detection module 110, may be preconfigured by the sender device 102 (e.g., as part of device settings), may be configured by a financial application (e.g., set by a user in the financial application), or some combination thereof. For instance, the threshold battery level may be associated with a low battery operation mode of the sender device 102.

At 804, a data transaction is initiated based on the battery level being below the threshold battery level. The data transaction is from a first account to a second account. In at least one implementation the first account is the sender account 116 associated with the sender device 102 and the second account is the receiving account 126 associated with the receiver device 104. The data transaction, for instance, represents a finance transaction initiated via the sender account 116 and such as via the sender transaction application 114. That is, the data transaction corresponds to the finance transaction at least based on the notion that data is generated and communicated in response to initiation of the finance transaction.

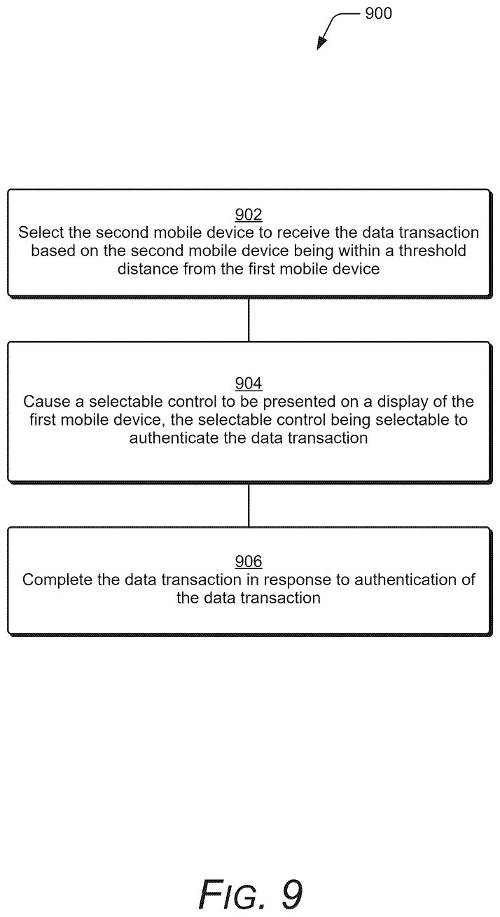

FIG. 9 illustrates example method(s) 900 for initiating transactions based on battery level. The order in which the method is described is not intended to be construed as a limitation, and any number or combination of the described method operations may be performed in any order to perform a method, or an alternate method. Operations of the method 900 may be performed at the sender device 102, the receiver device 104, the network transaction service 106, and/or cooperatively between one or more combinations of these entities. In at least one implementation the method(s) 900 can be implemented in conjunction with the method(s) 800.

At 902, a second mobile device is selected to receive a data transaction based on the second mobile device being within a threshold distance from a first mobile device. The data transaction may represent a finance transaction, for example, initiated via the sender transaction application 114. In at least one implementation, the first mobile device is the sender device 102 and the second mobile device is the receiver device 104. For instance, the linked device module 112 may detect that the receiver device 104 is within the threshold distance from the sender device 102. In some cases, the linked device module 112 and/or the linked device module 122 may detect that the receiver device 104 belongs to a group of linked devices to which the sender device 102 belongs. In some examples, the linked device module 112 may obtain location information of the receiver device 104 from a linked device application associated with the group of linked devices, and may determine that the receiver device 104 is within the threshold distance based on the location information.

At 904, a selectable control is caused to be presented on a display of the first mobile device, the selectable control being selectable to authenticate the data transaction. For example, the sender transaction GUI 120 may display the selectable control on a screen of the sender device 102. A user of the sender device 102 can select the selectable control to authenticate the data transaction.

At 906, the data transaction is completed in response to authentication of the data transaction. The data transaction is from a first account to a second account. In at least one implementation the first account is the sender account 116 associated with the sender device 102 and the second account is the receiving account 126 associated with the receiver device 104. In some examples, the sender transaction application 114 and the receiver transaction application 124 coordinate with the network transaction service 106 to complete the data transaction. For instance, the data transaction is completed and results in a transfer of a value amount (e.g., a monetary value amount) from a sender user account (e.g., the first account) to a receiver user account (e.g., the second account).

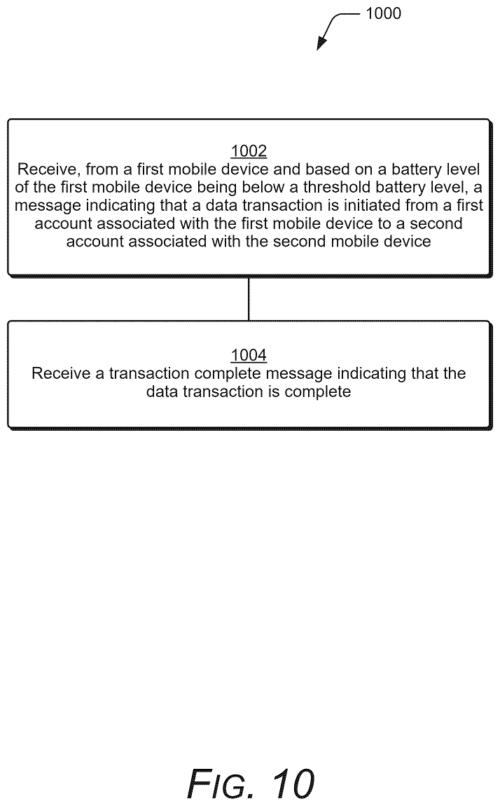

FIG. 10 illustrates example method(s) 1000 for initiating transactions based on battery level. The order in which the method is described is not intended to be construed as a limitation, and any number or combination of the described method operations may be performed in any order to perform a method, or an alternate method. Operations of the method 1000 may be performed at the sender device 102, the receiver device 104, the network transaction service 106, and/or cooperatively between one or more combinations of these entities.

At 1002 a message is received, from a first mobile device and based on a battery level of the first mobile device being below a threshold battery level, indicating that a data transaction is initiated from a first account associated with the first mobile device to a second account associated with the second mobile device. The data transaction, for instance, is from a first account to a second account. In implementations, the first account is the sender account 116 associated with the sender device 102 and the second account is the receiving account 126 associated with the receiver device 104. The data transaction may represent a finance transaction initiated via the first account and such as via the sender transaction application 114. In some examples, the receiver transaction application 124 receives the message from the sender transaction application 114 and/or the network transaction service 106. The data transaction, in some implementations, may be initiated based on a battery level being below a threshold battery level, such as a battery level of the sender device 102.

At 1004, a transaction complete message is received indicating that the data transaction is complete. In implementations, the receiver transaction application 124 receives the transaction complete message from the sender transaction application 114 and/or the network transaction service 106. In some examples, the sender transaction application 114 and the receiver transaction application 124 coordinate with the network transaction service 106 to complete the data transaction. The data transaction is completed and results in a transfer of a value amount (e.g., a monetary value amount) from a sender user account (e.g., the first account) to a receiver user account (e.g., the second account).

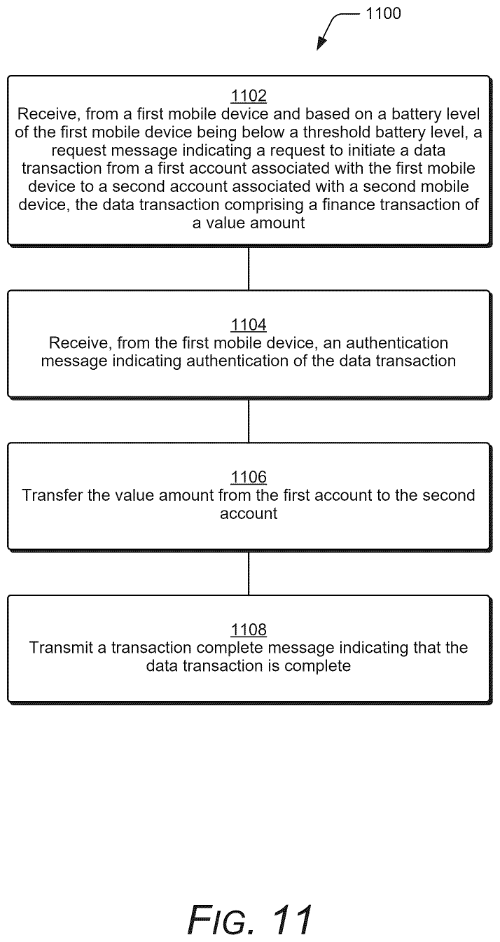

FIG. 11 illustrates example method(s) 1100 for initiating transactions based on battery level. The order in which the method is described is not intended to be construed as a limitation, and any number or combination of the described method operations may be performed in any order to perform a method, or an alternate method. Operations of the method 1100 may be performed at the sender device 102, the receiver device 104, the network transaction service 106, and/or cooperatively between one or more combinations of these entities.

At 1102, a request message is received, from a first mobile device and based on a battery level of the first mobile device being below a threshold battery level, indicating a request to initiate a data transaction from a first account associated with the first mobile device to a second account associated with a second mobile device. The data transaction may include or be an example of a finance transaction of a value amount (e.g., a monetary value amount) from the first account to the second account. For instance, the battery detection module 110 may detect that the battery level of the sender device 102 is below the threshold battery level. In at least one implementation, the first account is the sender account 116 associated with the sender device 102 and the second account is the receiving account 126 associated with the receiver device 104. For example, the sender transaction application 114 may transmit, and the network transaction service 106 may receive, the request message.

At 1104, an authentication message is received from the first mobile device indicating authentication of the data transaction. For example, a user may interact with the sender transaction GUI 120 to authenticate the data transaction based on the sender transaction application 114 initiating the data transaction. The sender transaction application 114 may transmit, and the network transaction service 106 may receive, the authentication message in response to the user authenticating the data transaction.

At 1106, the value amount is transferred from the first account to the second account. As an example, the network transaction service 106 performs the data transaction by transferring the value amount from the first account to the second account.

At 1108, a transaction complete message is transmitted indicating that the data transaction is complete. In some implementations, the network transaction service 106 transmits the transaction complete message to the sender device 102 and/or the receiver device 104, e.g., based on transferring the value amount from the first account to the second account.

FIG. 12 illustrates various components of an example device 1200, which can implement aspects of the techniques and features for initiating transactions based on battery level, as described herein. The example device 1200 may be implemented as any of the devices described with reference to the previous FIGS. 1-11, such as any type of a wireless device, mobile device, mobile phone, flip phone, client device, companion device, display device, tablet, computing, communication, entertainment, gaming, media playback, and/or any other type of computing and/or electronic device. For example, the sender device 102 and the receiver device 104 as described with reference to FIGS. 1-11 may each be implemented as the example device 1200.

The example device 1200 can include various, different communication devices 1202 that enable wired and/or wireless communication of device data 1204 with other devices. The device data 1204 can include any of the various devices' data and content that is generated, processed, determined, received, stored, and/or communicated from one computing device to another. The device data 1204 can include any form of audio, video, image, graphics, and/or electronic data that is generated by applications executing on a device. The communication devices 1202 can also include transceivers for cellular phone communication and/or for any type of network data communication.

The example device 1200 can also include various, different types of data input/output (I/O) interfaces 1206, such as data network interfaces that provide connection and/or communication links between the devices, data networks, and other devices. The data I/O interfaces 1206 may be used to couple the device to any type of components, peripherals, and/or accessory devices, such as a computer input device that may be integrated with the example device 1200. The I/O interfaces 1206 may also include data input ports via which any type of data, information, media content, communications, messages, and/or inputs may be received, such as user inputs to the device, as well as any type of audio, video, image, graphics, and/or electronic data received from any content and/or data source.

The example device 1200 includes a processor system 1208 of one or more processors (e.g., any of microprocessors, controllers, and the like) and/or a processor and memory system implemented as a system-on-chip (SoC) that processes computer-executable instructions. The processor system 1208 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device may be implemented with any one or combination of software, hardware, firmware, or fixed logic circuitry that may be implemented in connection with processing and control circuits, which are identified at 1210. The example device 1200 may also include any type of a system bus or other data and command transfer system that couples the various components within the device. A system bus can include any one or combination of different bus structures and architectures, as well as control and data lines.

The example device 1200 also includes memory and/or memory devices 1212 (e.g., computer-readable storage memory) that enable data storage, such as data storage devices implemented in hardware which may be accessed by a computing device, and that provide persistent storage of data and executable instructions (e.g., software applications, programs, functions, and the like). Examples of the memory devices 1212 include volatile memory and non-volatile memory, fixed and removable media devices, and any suitable memory device or electronic data storage that maintains data for computing device access. The memory devices 1212 can include various implementations of random-access memory (RAM), read-only memory (ROM), flash memory, and other types of storage media in various memory device configurations. The example device 1200 may also include a mass storage media device.

The memory devices 1212 (e.g., as computer-readable storage memory) provide data storage mechanisms, such as to store the device data 1204, other types of information and/or electronic data, and various device applications 1214 (e.g., software applications and/or modules). For example, an operating system 1216 may be maintained as software instructions with a memory device 1212 and executed by the processor system 1208 as a software application. The device applications 1214 may also include a device manager, such as any form of a control application, software application, signal-processing and control module, code that is specific to a particular device, a hardware abstraction layer for a particular device, and so on.

In this example, the device 1200 includes a transaction application 1218 that implements various aspects of the described features and techniques described herein. The transaction application 1218 may be implemented with hardware components and/or in software as one of the device applications 1214, such as when the example device 1200 is implemented as the sender device 102 and/or the receiver device 104 described with reference to FIGS. 1-11. An example of the transaction application 1218 is the sender transaction application 114 implemented by the sender device 102, such as a software application and/or as hardware components in the sender device 102. Another example of the transaction application 1218 is the receiver transaction application 124 implemented by the receiver device 104, such as a software application and/or as hardware components in the receiver device 104. In implementations, the transaction application 1218 may include independent processing, memory, and logic components as a computing and/or electronic device integrated with the example device 1200.

The example device 1200 can also include a microphone 1220 (e.g., to capture an audio recording of a user) and/or camera devices 1222 (e.g., to capture video images of the user during a call), as well as device sensors 1224, such as may be implemented as components of an inertial measurement unit (IMU). The device sensors 1224 may be implemented with various sensors, such as a gyroscope, an accelerometer, and/or other types of motion sensors to sense motion of the device. The device sensors 1224 can generate sensor data vectors having three-dimensional parameters (e.g., rotational vectors in x, y, and z-axis coordinates) indicating location, position, acceleration, rotational speed, and/or orientation of the device. The example device 1200 can also include one or more power sources 1226, such as when the device is implemented as a wireless device and/or a mobile device. The power sources may include a charging and/or power system, and may be implemented as a flexible strip battery, a rechargeable battery, a charged super-capacitor, and/or any other type of active or passive power source.

The example device 1200 can also include an audio and/or video processing system 1228 that generates audio data for an audio system 1230 and/or generates display data for a display system 1232. The audio system and/or the display system may include any types of devices or modules that generate, process, display, and/or otherwise render audio, video, display, and/or image data. Display data and audio signals may be communicated to an audio component and/or to a display component via any type of audio and/or video connection or data link. In implementations, the audio system and/or the display system are integrated components of the example device 1200. Alternatively, the audio system and/or the display system are external, peripheral components to the example device.

Although implementations for initiating transactions based on battery level have been described in language specific to features and/or methods, the appended claims are not necessarily limited to the specific features or methods described. Rather, the specific features and methods are disclosed as example implementations for initiating transactions based on battery level, and other equivalent features and methods are intended to be within the scope of the appended claims. Further, various different examples are described, and it is to be appreciated that each described example may be implemented independently or in connection with one or more other described examples. Additional aspects of the techniques, features, and/or methods discussed herein relate to one or more of the following:

In some aspects, the techniques described herein relate to a first mobile device including: at least one memory; and at least one processor coupled with the at least one memory and configured to cause the first mobile device to: detect that a battery level of the first mobile device is below a threshold battery level; and initiate, based at least in part on the battery level of the first mobile device being below the threshold battery level, a data transaction from a first account associated with the first mobile device to a second account associated with a second mobile device.

In some aspects, the techniques described herein relate to a first mobile device, wherein the at least one processor is configured to cause the first mobile device to complete the data transaction in response to authentication of the data transaction.

In some aspects, the techniques described herein relate to a first mobile device, wherein to complete the data transaction, the at least one processor is configured to cause a selectable control to be presented on a display of the first mobile device, the selectable control being selectable to authenticate the data transaction.

In some aspects, the techniques described herein relate to a first mobile device, wherein the at least one processor is configured to cause a selectable control to be presented on a display of the first mobile device, the selectable control being selectable to accept or deny the data transaction.

In some aspects, the techniques described herein relate to a first mobile device, wherein the at least one processor is configured to cause the first mobile device to complete the data transaction in response to the selectable control being selected to accept the data transaction.

In some aspects, the techniques described herein relate to a first mobile device, wherein the at least one processor is configured to cause the first mobile device to abort the data transaction in response to the selectable control being selected to deny the data transaction.

In some aspects, the techniques described herein relate to a first mobile device, wherein to initiate the data transaction, the at least one processor is configured to cause the first mobile device to select the second mobile device to receive the data transaction based at least in part on the second mobile device being within a threshold distance from the first mobile device.

In some aspects, the techniques described herein relate to a first mobile device, wherein the data transaction comprises a finance transaction of a value amount transferred from the first account to the second account.

In some aspects, the techniques described herein relate to a first mobile device, wherein the value amount is preconfigured in a digital wallet application on the first mobile device and associated with the first account.

In some aspects, the techniques described herein relate to a first mobile device, wherein the at least one processor is configured to cause the first mobile device to display a prompt indicating to input the value amount.

In some aspects, the techniques described herein relate to a first mobile device, wherein the at least one processor is configured to cause the first mobile device to detect that the battery level of the first mobile device is above the threshold battery level; and initiate a second data transaction from the second account to the first account based at least in part on the battery level of the first mobile device being above the threshold battery level.

In some aspects, the techniques described herein relate to a first mobile device, wherein the data transaction comprises a first finance transaction of a first value amount transferred from the first account to the second account and the second data transaction comprises a second finance transaction of a second value amount transferred from the second account to the first account, the second value amount being equal to or less than the first value amount.

In some aspects, the techniques described herein relate to a first mobile device, wherein the threshold battery level is preconfigured, selected by a user of the first mobile device, or configured on a digital wallet application on the first mobile device and associated with the first account.

In some aspects, the techniques described herein relate to a first mobile device, wherein the first mobile device and the second mobile device belong to a group of linked mobile devices.

In some aspects, the techniques described herein relate to a first mobile device, wherein the at least one processor is configured to cause the first mobile device to transmit, to the second mobile device based at least in part on initiating the data transaction, a message indicating that the data transaction is pending; and transmit, to the second mobile device based at least in part on completing the data transaction, a transaction complete message indicating that the data transaction is complete.

Alternatively, or in addition to the above-described first mobile device, any one or combination of:

A second mobile device, including at least one memory; and at least one processor coupled with the at least one memory and configured to cause the second mobile device to receive, from a first mobile device and based at least in part on a battery level of the first mobile device being below a threshold battery level, a message indicating that a data transaction is initiated from a first account associated with the first mobile device to a second account associated with the second mobile device; and receive a transaction complete message indicating that the data transaction is complete.

In some aspects, the techniques described herein relate to a second mobile device, wherein the at least one processor is configured to cause a selectable control to be presented on a display of the second mobile device, the selectable control being selectable to accept or deny the data transaction.

In some aspects, the techniques described herein relate to a second mobile device, wherein the at least one processor is configured to cause the second mobile device to receive, from the first mobile device and based at least in part on the battery level of the first mobile device being above the threshold battery level, a second message indicating that a second data transaction is initiated, where the data transaction comprises a first finance transaction of a first value amount transferred from the first account to the second account and the second data transaction comprises a second finance transaction of a second value amount transferred from the second account to the first account, the second value amount being equal to or less than the first value amount.

Alternatively, or in addition to the above-described second mobile device, any one or combination of:

A system, comprising: at least one memory; and at least one processor coupled with the at least one memory and configured to cause the system to receive, from a first mobile device and based at least in part on a battery level of the first mobile device being below a threshold battery level, a request message indicating a request to initiate a data transaction from a first account associated with the first mobile device to a second account associated with a second mobile device, the data transaction comprising a finance transaction of a value amount; receive, from the first mobile device, an authentication message indicating authentication of the data transaction; transfer the value amount from the first account to the second account; and transmit a transaction complete message indicating that the data transaction is complete.

In some aspects, the techniques described herein relate to a system, wherein the at least one processor is configured to cause the system to receive, from the first mobile device and based at least in part on the battery level of the first mobile device being above the threshold battery level, a second request message indicating a second request to initiate a second data transaction, the second data transaction comprising a second finance transaction of a second value amount from the first account to the second account, where the second value amount is less than or equal to the value amount; and transfer the second value amount from the second account to the first account.

What is claimed is:

1. A first mobile device, comprising:
at least one memory; and
at least one processor coupled with the at least one memory and configured to cause the first mobile device to:
detect that a battery level of the first mobile device is below a threshold battery level; and
initiate, based at least in part on the battery level of the first mobile device being below the threshold battery level, a data transaction from a first account associated with the first mobile device to a second account associated with a second mobile device.

2. The first mobile device of claim 1, wherein the at least one processor is configured to cause the first mobile device to complete the data transaction in response to authentication of the data transaction.

3. The first mobile device of claim 2, wherein, to complete the data transaction, the at least one processor is configured to cause a selectable control to be presented on a display of the first mobile device, the selectable control being selectable to authenticate the data transaction.

4. The first mobile device of claim 1, wherein the at least one processor is configured to cause a selectable control to be presented on a display of the first mobile device, the selectable control being selectable to accept or deny the data transaction.

5. The first mobile device of claim 4, wherein the at least one processor is configured to cause the first mobile device to complete the data transaction in response to the selectable control being selected to accept the data transaction.

6. The first mobile device of claim 4, wherein the at least one processor is configured to cause the first mobile device to abort the data transaction in response to the selectable control being selected to deny the data transaction.

7. The first mobile device of claim 1, wherein, to initiate the data transaction, the at least one processor is configured to cause the first mobile device to select the second mobile device to receive the data transaction based at least in part on the second mobile device being within a threshold distance from the first mobile device.

8. The first mobile device of claim 1, wherein the data transaction comprises a finance transaction of a value amount transferred from the first account to the second account.

9. The first mobile device of claim 8, wherein the value amount is preconfigured in a digital wallet application on the first mobile device and associated with the first account.

10. The first mobile device of claim 8, wherein the at least one processor is configured to cause the first mobile device to display a prompt indicating to input the value amount.

11. The first mobile device of claim 1, wherein the at least one processor is configured to cause the first mobile device to:
detect that the battery level of the first mobile device is above the threshold battery level; and
initiate a second data transaction from the second account to the first account based at least in part on the battery level of the first mobile device being above the threshold battery level.

12. The first mobile device of claim 11, wherein the data transaction comprises a first finance transaction of a first value amount transferred from the first account to the second account and the second data transaction comprises a second finance transaction of a second value amount transferred from the second account to the first account, the second value amount being equal to or less than the first value amount.

13. The first mobile device of claim 1, wherein the threshold battery level is preconfigured, selected by a user of the first mobile device, or configured on a digital wallet application on the first mobile device and associated with the first account.

14. The first mobile device of claim 1, wherein the first mobile device and the second mobile device belong to a group of linked mobile devices.

15. The first mobile device of claim 1, wherein the at least one processor is configured to cause the first mobile device to:
transmit, to the second mobile device based at least in part on initiating the data transaction, a message indicating that the data transaction is initiated; and
transmit, to the second mobile device based at least in part on completing the data transaction, a transaction complete message indicating that the data transaction is complete.

16. A second mobile device, comprising:
at least one memory; and
at least one processor coupled with the at least one memory and configured to cause the second mobile device to:
receive, from a first mobile device and based at least in part on a battery level of the first mobile device being below a threshold battery level, a message indicating that a data transaction is initiated from a first account associated with the first mobile device to a second account associated with the second mobile device; and
receive a transaction complete message indicating that the data transaction is complete.

17. The second mobile device of claim 16, wherein the at least one processor is configured to cause a selectable control to be presented on a display of the second mobile device, the selectable control being selectable to accept or deny the data transaction.

18. The second mobile device of claim 16, wherein the at least one processor is configured to cause the second mobile device to receive, from the first mobile device and based at least in part on the battery level of the first mobile device being above the threshold battery level, a second message indicating that a second data transaction is initiated, wherein the data transaction comprises a first finance transaction of a first value amount transferred from the first account to the second account and the second data transaction comprises a second finance transaction of a second value amount transferred from the second account to the first account, the second value amount being equal to or less than the first value amount.

19. A system, comprising:
at least one memory; and
at least one processor coupled with the at least one memory and configured to cause the system to:
receive, from a first mobile device and based at least in part on a battery level of the first mobile device being below a threshold battery level, a request message indicating a request to initiate a data transaction from a first account associated with the first mobile device to a second account associated with a second mobile device, the data transaction comprising a finance transaction of a value amount;
receive, from the first mobile device, an authentication message indicating authentication of the data transaction;
transfer the value amount from the first account to the second account; and
transmit a transaction complete message indicating that the data transaction is complete.

20. The system of claim 19, wherein the at least one processor is configured to cause the system to:
receive, from the first mobile device and based at least in part on the battery level of the first mobile device being above the threshold battery level, a second request message indicating a second request to initiate a second data transaction, the second data transaction comprising a second finance transaction of a second value amount from the first account to the second account, wherein the second value amount is less than or equal to the value amount; and
transfer the second value amount from the second account to the first account.
